(19) United States
(12) Patent Application Publication
(10) Pub. No.: US 2012/0105331 A1
(43) Pub. Date: May 3, 2012

(54) PORTABLE ELECTRONIC DEVICE

(75) Inventor: Akihiro Nomoto, Kanagawa (JP)

(73) Assignee: KYOCERA CORPORATION, Kyoto (JP)

(21) Appl. No.: 13/280,658

(22) Filed: Oct. 25, 2011

(30) Foreign Application Priority Data
Oct. 27, 2010 (JP) 2010-241470

(51) Int. Cl. G06F 3/02; G06F 3/041

(52) U.S. Cl. 345/169; 345/173

(57) ABSTRACT

An object of the present invention is to provide a portable electronic device capable of suppressing incorrect inputs. A control unit of a cellular telephone device detects a distance between an object in proximity to a display unit and a display surface of the display unit, and a position on the display unit corresponding to the distance, causes the display unit to display a keyboard configured with a plurality of images displaying keys, and in response to a contact detecting unit having detected contact of an object to the display unit, the control unit accepts an input of a key corresponding to the image. The control unit causes the display unit to display images, which are displayed within a predetermined range from the position detected on the display unit, in an enlarged manner.

This application is based on and claims the benefit of priority from Japanese Patent Application No. 2010-241470, filed on 27 Oct. 2010, the content of which is incorporated herein by reference.

### BACKGROUND OF THE INVENTION

1. Field of the Invention

The present invention relates to a portable electronic device that detects contact of an object to a display unit.

2. Related Art

In recent years, an increasing number of portable electronic devices have been provided with a touch panel capable of performing various operations or inputting characters by detecting contact of a pen or a finger. Such a portable electronic device is provided with a touch panel that includes: a display unit such as an LCD (Liquid Crystal Display); and a detecting unit for detecting contact on the display unit. In addition, in the portable electronic device, the display unit displays various keys such as for characters or buttons, and the detecting unit detects that a finger or a pen touches a portion (touch operation area) where the various keys are displayed, thereby accepting inputs of the various keys.

However, in such a portable electronic device, the size of the display unit is small as compared to a display unit without portability, etc. Accordingly, in such a portable electronic device, the size of displayed buttons or keys tends to be small. In this way, in a case in which the size of buttons or keys is small, it is difficult to correctly input various keys via a touch panel, and incorrect inputs are likely to occur. Therefore, in order to solve such a problem, for example, a method has been proposed to increase the size of a touch operation area corresponding to characters that were frequently input in the past (for example, see Japanese Unexamined Patent Application, Publication No. 2007-280153).

### SUMMARY OF THE INVENTION

However, in the method disclosed in Patent Document 1, although frequently-input characters become easy to input, the size of a touch operation area is not enlarged when less-frequently-input characters are input. Therefore, in the method disclosed in Patent Document 1, incorrect inputs may occur when less-frequently-input characters are input. Therefore, a portable electronic device capable of suppressing incorrect inputs has been desired.

An object of the present invention is to provide a portable electronic device capable of suppressing incorrect inputs.

The portable electronic device according to the present invention includes: a display unit; a contact detecting unit that detects contact of an object to the display unit; a proximity detecting unit that detects proximity of the object in proximity to a display surface of the display unit; and a control unit that causes the display unit to display images, which are displayed within a predetermined range of the display surface facing the object, in an enlarged manner, in a case in which the proximity detecting unit detects proximity of the object to the display surface.

Moreover, in the portable electronic device, it is preferable that the proximity detecting unit detects a distance between the object in proximity to the display unit and the display surface of the display unit, and a position on the display unit corresponding to the distance, and the control unit causes the display unit to display a keyboard configured with a plurality of images displaying keys, accepts an input of the key corresponding to the image in response to the contact detecting unit having detected contact of the object to the image, and causes the display unit to display the images, which are displayed within a predetermined range from the position on the display unit detected by the proximity detecting unit, in an enlarged manner.

In addition, in the portable electronic device, it is preferable that, in a case in which the distance detected by the proximity detecting unit is shorter than a first distance, the control unit causes the display unit to display the images, which are displayed within the predetermined range, in an enlarged manner.

Furthermore, in the portable electronic device, it is preferable that the control unit causes the display unit to display the images, which are displayed within the predetermined range, in an enlarged and semi-transmissive manner.

Moreover, in the portable electronic device, it is preferable that, in a case in which the distance detected by the proximity detecting unit is shorter than a second distance that is shorter than the first distance, the control unit performs control such that the images, which are displayed in an enlarged manner on the display unit, are displayed without any changes in accordance with the position.

In addition, in the portable electronic device, it is preferable that, in a case in which the distance detected by the proximity detecting unit is shorter than the second distance, the control unit performs control such that the images, which are displayed in an enlarged manner on the display unit, are displayed in a highlighted and statical manner.

Furthermore, in the portable electronic device, it is preferable that, in a case in which the distance detected by the proximity detecting unit is shorter than a third distance that is shorter than the second distance, the control unit changes a display manner of the image corresponding to the position on the display unit detected by the proximity detecting unit, and accepts an input of the key corresponding to the image whose display manner was changed in response to the contact detecting unit having detected contact of the object to the display unit.

According to the present invention, incorrect inputs can be suppressed.

### BRIEF DESCRIPTION OF THE DRAWINGS

FIG. 1 is a perspective view showing an appearance of a cellular telephone device according to an embodiment of the portable electronic device;

FIG. 2 is a block diagram showing a functional configuration of the cellular telephone device;

FIG. 3 is a view showing an example in which an object is brought closer to a display unit of the cellular telephone device;

FIG. 4 is a view showing an example in which a virtual keyboard is displayed on the display unit;

FIG. 5 is a view showing an example in which a part of the virtual keyboard is displayed in an enlarged manner on the display unit;

FIG. 6 is a view showing an example in which a part of the virtual keyboard is displayed in an enlarged and semi-transmissive manner on the display unit;

FIG. 7 is a view showing an example in which keys being displayed in an enlarged manner are displayed in a highlighted manner on the display unit;

FIG. 8 is a view showing an example in which keys are displayed in an enlarged manner, one of which is displayed in an altered display manner, on the display unit; and

FIG. 9 is a flowchart showing a flow of processing by a control unit of the cellular telephone device.

### DETAILED DESCRIPTION OF THE INVENTION

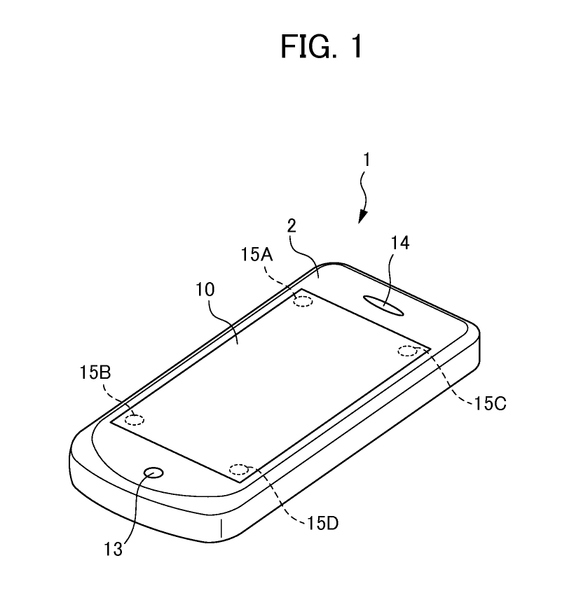

Descriptions are provided hereinafter regarding an embodiment of the present invention. First of all, with reference to FIG. 1, descriptions are provided for a basic structure of a cellular telephone device 1 according to an embodiment of the portable electronic device of the present invention. FIG. 1 is a perspective view showing an appearance of the cellular telephone device 1 according to the present embodiment.

The cellular telephone device 1 includes a body 2. A touch panel 10, a microphone 13 and a speaker 14 are disposed on a front face portion of the body 2. Moreover, inside the body 2, a plurality of proximity sensors 15A, 15B, 15C and 15D are disposed so as to correspond to four corners of the touch panel 10 (the proximity sensors 15A, 15B, 15C and 15D are also hereinafter collectively referred to as the proximity sensor 15).

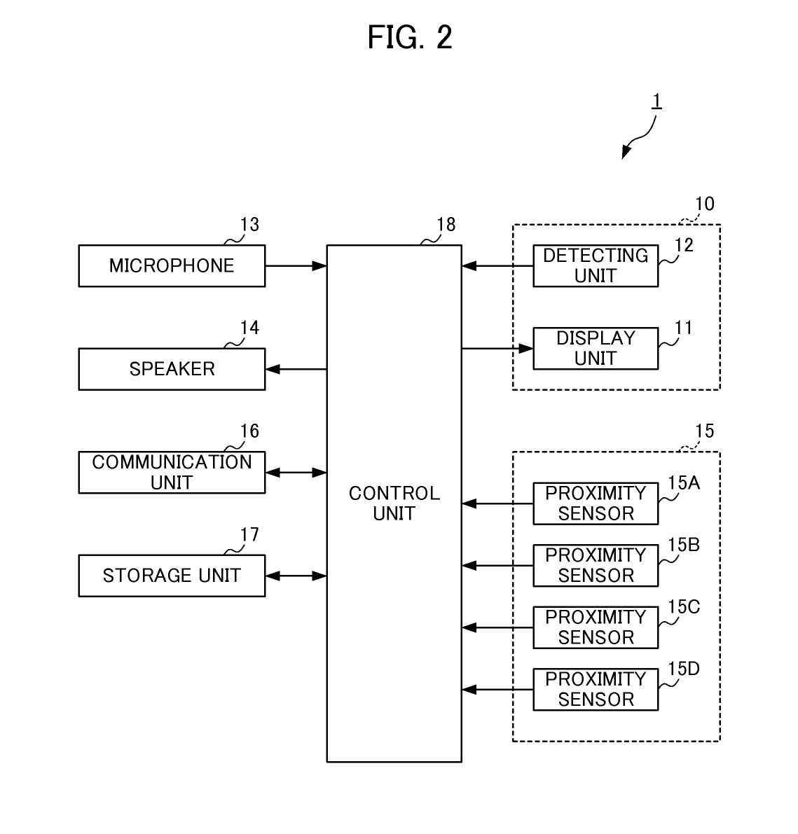

The touch panel 10 includes a display unit 11 and a contact detecting unit 12 (see FIG. 2). The display unit 11 is a liquid-crystal display panel, an organic EL (electroluminescence) display panel, or the like. The contact detecting unit 12 is a sensor that detects contact of an object, such as a finger or stylus of a user of the cellular telephone device 1, to the display unit 11. For example, a sensor that employs a capacitive sensing method or a resistive film method can be utilized as the contact detecting unit 12.

The microphone 13 is used for inputting sound produced by the user of the cellular telephone device 1 during a telephone call.

The speaker 14 is used for outputting sound produced by the other party whom the user of the cellular telephone device 1 is talking with.

The proximity sensor 15 detects a distance to an object that is in proximity to the display unit 11. The distance thus detected is input into a control unit 18 that will be described later. For example, a sensor that employs an induction method, a capacitive sensing method, an ultrasonic method, an electromagnetic wave method, or an infrared ray method can be utilized as the proximity sensor 15.

Next, a functional configuration of the cellular telephone device 1 is described with reference to FIG. 2. FIG. 2 is a block diagram showing a functional configuration of the cellular telephone device 1.

The cellular telephone device 1 includes the touch panel (the display unit 11 and the contact detecting unit 12), the microphone 13, the speaker 14 and the proximity sensor 15, as described above. In addition, the cellular telephone device 1 includes a communication unit 16, a storage unit 17, and the control unit 18 serving as a proximity detecting unit and control unit.

The communication unit 16 includes a main antenna (not illustrated) and an RF circuit unit (not illustrated), and performs communication with a predetermined contact entity. The contact entity, to which the communication unit 16 makes an outgoing call, is an external device that performs a telephone call or mail transmission/reception with the cellular telephone device 1, or an external device or the like such as an external web server, with which the cellular telephone device 1 establishes Internet connections.

The communication unit 16 performs communication with an external device in a predetermined usable frequency band. More specifically, the communication unit 16 performs demodulation processing of a signal received via the main antenna, and transmits the processed signal to the control unit 18. The communication unit 16 performs modulation processing of a signal transmitted from the control unit 18, and transmits the signal to an external device (base station) via the main antenna.

The storage unit 17 includes, for example, working memory, and is utilized for arithmetic processing by the control unit 18. Furthermore, the storage unit 17 stores a single or plurality of applications that are operated inside the cellular telephone device 1. It should be noted that the storage unit 17 may also serve as detachable external memory.

The control unit 18 controls the entirety of the cellular telephone device 1, and performs control of the display unit 11 or the communication unit 16. In the present embodiment, when accepting an operation of inputting a character string in a mail function or a memo pad function via the contact detecting unit 12, the control unit 18 causes the display unit 11 to display a virtual keyboard that is configured with images corresponding to a plurality of areas displaying keys. In addition, based on a distance that is input from the proximity sensor 15, the control unit 18 performs control of changing the display manner of the virtual keyboard. Descriptions are hereinafter provided for a configuration and operations for achieving the aforementioned functions according to the cellular telephone device 1.

In response to accepting an operation for inputting a character string, the control unit 18 causes the display unit 11 to display the virtual keyboard such that the entire keyboard is displayed. Moreover, in response to the contact detecting unit 12 having detected contact of an object to any of the images corresponding to the plurality of areas configuring the virtual keyboard displayed on the display unit 11, the control unit 18 accepts an input of the key corresponding to the image.

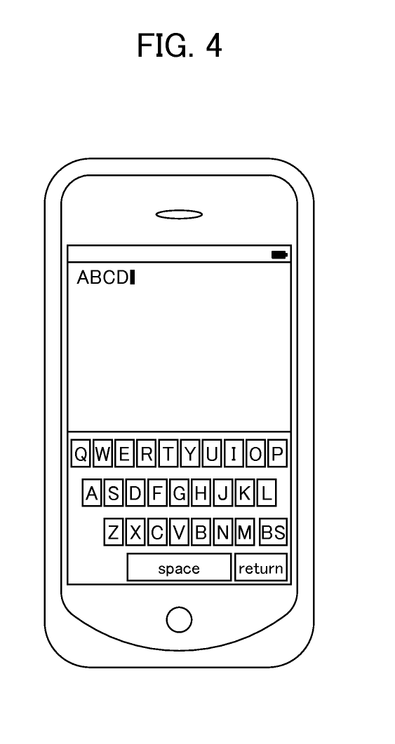

FIG. 4 is a view showing an example in which the virtual keyboard is displayed on the display unit 11. In FIG. 4, it is possible to confirm that a QWERTY virtual keyboard is displayed on a part of the display unit 11. In other words, in FIG. 4, it is possible to confirm that the virtual keyboard is formed with images corresponding to a plurality of areas, and the keys are displayed correspondingly to the plurality of images. For example, when an image corresponding to an area displaying “Q” is touched by a finger or a pen, the control unit 18 accepts an input of “Q”.

In a case in which the proximity sensor 15 detects proximity of an object such as a finger or stylus of the user to the display surface of the display unit 11, the control unit 18 causes the display unit 11 to display images, which are displayed within a predetermined range of the display surface of the display unit 11 facing the object, in an enlarged manner.

More specifically, in a state where the virtual keyboard is displayed on the display unit 11, based on a distance to the object which is input by way of the plurality of proximity sensors 15A, 15B, 15C and 15D, the control unit 18 detects a distance to the object in proximity to the display unit 11 relative to the display surface of the display unit 11, and detects a position on the display unit 11 corresponding to the distance.

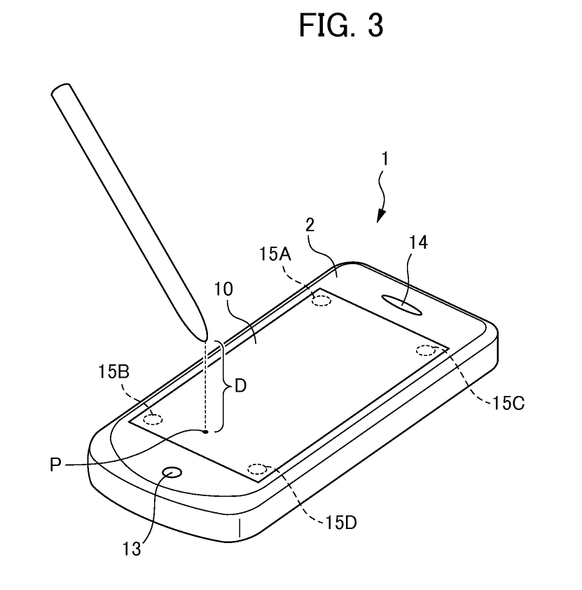

FIG. 3 is a view showing an example in which a stylus as an object is brought closer to the display unit 11 of the cellular telephone device 1. As shown in FIG. 3, a distance to the object in proximity to the display unit 11 relative to the display surface of the display unit 11 is detected by the control unit 18, and is referred to as a distance D. In addition, a position corresponding to the distance D on the display unit 11 is referred to as a position P.

Subsequently, the control unit 18 causes the display unit 11 to display an image, which corresponds to an area displayed within a predetermined range from the detected position P on the display unit 11, and the key corresponding to the image, in an enlarged manner. Here, the predetermined range is, for example, areas being adjacent to the area including the position P.

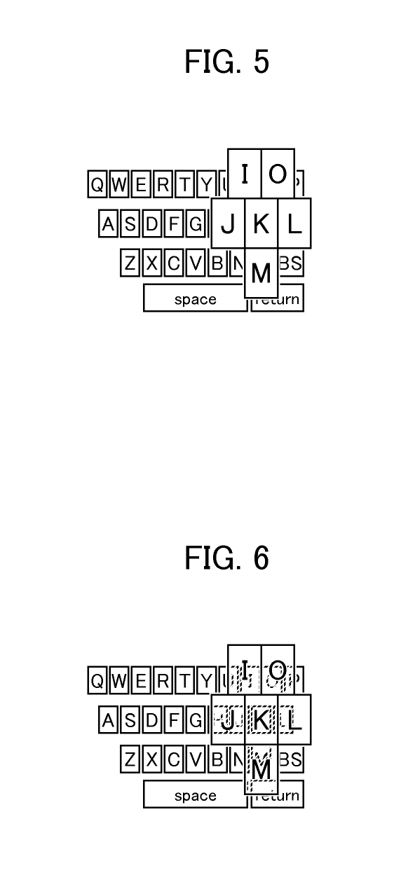

FIG. 5 is a view showing an example in which a part of the virtual keyboard is displayed in an enlarged manner on the display unit 11. In the example shown in FIG. 5, the position P is a position corresponding to an image of an area that displays “K”. In addition, in FIG. 5, it is possible to confirm that the image of the area corresponding to “K” and images of areas corresponding to “I”, “O”, “J”, “L” and “M”, which are keys corresponding images in areas adjacent to each other in areas including the position P, are displayed in an enlarged manner.

By doing this way, in a case in which an object such as a finger or stylus of the user is brought closer to the display surface of the display unit 11, the cellular telephone device 1 causes the display unit 11 to display images, which are displayed within a predetermined range of the display surface of the display unit 11 facing the object, in an enlarged manner. Therefore, the cellular telephone device 1 can improve the operability for areas within a predetermined range, and can suppress incorrect inputs.

Furthermore, in a case in which an object such as a finger or stylus of the user is brought closer to a key that the user is going to input, the cellular telephone device 1 displays images, which are in areas displayed within a predetermined range from the area in a position close to the object, in an enlarged manner. Accordingly, the cellular telephone device 1 can improve the visibility of keys corresponding to images, and can enlarge the touch-sensitive images corresponding to the keys; therefore, it is possible to suppress incorrect inputs.

Next, descriptions are provided for processing by the control unit 18 to treat the distance D.

In a case in which the distance D is longer than a first distance d₁, as shown in FIG. 4, the control unit 18 displays the virtual keyboard such that the entire keyboard is displayed.

Moreover, in a case in which the distance D is shorter than the first distance d₁, as shown in FIG. 5, the control unit 18 causes the display unit 11 to display images, which correspond to areas being displayed within a predetermined range, in an enlarged manner.

By doing this way, in a case in which the distance between the display unit 11 and the object such as a finger or stylus of the user is shorter than the first distance d₁, the cellular telephone device 1 displays the images corresponding to the areas in an enlarged manner. Accordingly, the cellular telephone device 1 can let the user freely select areas to be displayed in an enlarged manner, only in a case in which the user brings a finger, a pen or the like to be closer to the display unit 11.

It should be noted that, in a case in which the distance D is shorter than the first distance d₁, the control unit 18 may cause the display unit 11 to display images, which correspond to areas displayed within a predetermined range, in an enlarged and semi-transmissive manner.

FIG. 6 is a view showing an example in which a part of the virtual keyboard is displayed in an enlarged and semi-transmissive manner on the display unit 11. In an example shown in FIG. 6, it is possible to confirm that the keys “K”, “I”, “O”, “J”, “L” and “M” are displayed in an enlarged and semi-transmissive manner, where the entire keyboard is displayed. By doing this way, in the cellular telephone device 1, even in a case in which images corresponding to a certain area are displayed in an enlarged manner, the entire keyboard can be displayed, and it is possible to prevent a case in which an area that is newly desired to be enlarged is not displayed.

In addition, in a case in which the distance D is shorter than a second distance d₂ that is shorter than the first distance d₁, the control unit 18 displays images, which correspond to areas displayed in an enlarged manner on the display unit 11, without any changes in accordance with the position P (statical display). Here, the statical display refers to fixing images that are displayed in an enlarged manner, and not changing the range of images that are already displayed in an enlarged manner, even if the position P is changed.

By doing this way, in the cellular telephone device 1, in a case in which the distance D is shorter than the second distance d₂, images being displayed in an enlarged manner can be prevented from being frequently changed due to camera shake or the like by the user.

It should be noted that, in a case in which the distance D is shorter than the second distance d₂, the control unit 18 may perform control such that the images being displayed in an enlarged and statical manner are displayed in a display manner that is different from the display manner in which the statical display is not performed. More specifically, in a case in which the distance D is shorter than the second distance d₂, the control unit 18 may cause the display unit 11 to display keys, which are displayed in an enlarged and statical manner, in a highlighted manner.

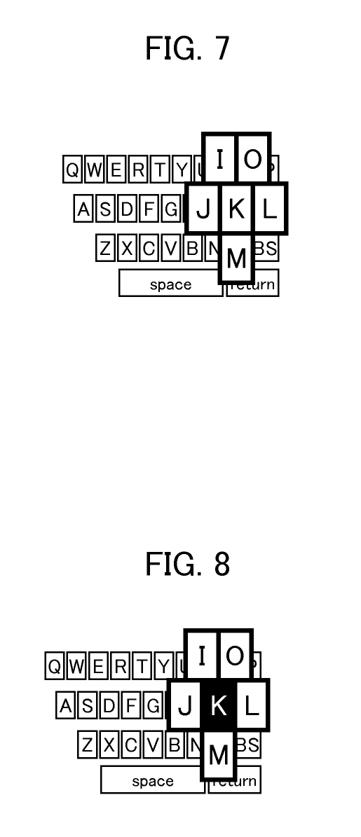

FIG. 7 is a view showing an example in which keys being displayed in an enlarged manner are displayed in a highlighted manner on the display unit 11. In an example shown in FIG. 7, it is possible to confirm that the images in the areas of the keys “K”, “I”, “O”, “J”, “L” and “M” that are displayed in an enlarged manner are displayed in a highlighted manner, as compared to the images being displayed in an enlarged manner in FIG. 5. By doing this way, in the cellular telephone device 1, by changing the display manner between the case in which the statical display is performed, and the case in which the statical display is not performed, the user can easily recognize that images being displayed in an enlarged manner are displayed in a statical manner.

Furthermore, in a case in which the distance D is shorter than a third distance d₃ that is shorter than the second distance d₂, the control unit 18 changes the display manner of an image in an area corresponding to the position P corresponding to the distance D. In addition, in response to the contact detecting unit 12 having detected contact of an object to the display unit 11, the control unit 18 accepts an input of the key corresponding to an image whose display manner was changed.

FIG. 8 is a view showing an example in which keys are displayed in an enlarged manner, one of which is displayed in an altered display manner, on the display unit 11. In the example shown in FIG. 8, an image corresponding to an area displaying “K” is in the position P, and the distance D is shorter than the third distance d₃. In this case, in FIG. 8, it is possible to confirm that the display manner of the image in the area corresponding to “K” has been changed by the control unit 18 from the display manner of the images in the other areas. By doing this way, in the cellular telephone device 1, the user can easily recognize that the image whose display manner has been changed is an image in the area that is closest to the finger or pen of the user, and that it is possible to input the key corresponding to the image.

Next, descriptions are provided for processing by the control unit 18.

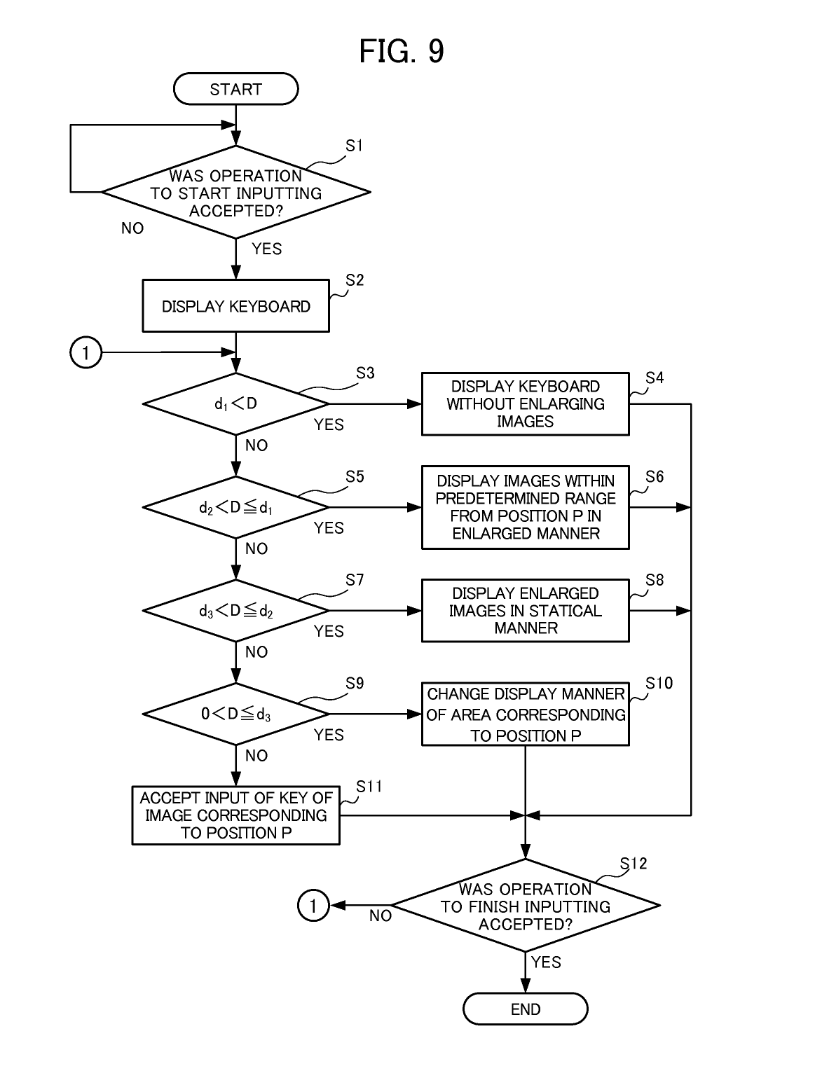

FIG. 9 is a flowchart showing a flow of processing by the control unit 18 of the cellular telephone device 1.

In Step S1, via the contact detecting unit 12, the control unit 18 determines whether an operation to start inputting a character string was accepted in a mail function or a memo pad function. In a case in which the determination is YES, the control unit 18 advances the processing to Step S2, and in a case in which the determination is NO, the control unit 18 repeats the processing of Step S1.

In Step S2, the control unit 18 causes the display unit 11 to display a virtual keyboard.

In Step S3, the control unit 18 determines whether a detected distance D is longer than the first distance d₁. In a case in which the determination is YES, the control unit 18 advances the processing to Step S4, and in a case in which the determination is NO, the control unit 18 advances the processing to Step S5.

In Step S4, the control unit 18 causes the display unit 11 to display the virtual keyboard without enlarging images. Subsequently, the control unit 18 advances the processing to Step S12.

In Step S5, the control unit 18 determines whether the detected distance D is longer than the second distance d₂, and is no more than the first distance d₁. In a case in which the determination is YES, the control unit 18 advances the processing to Step S6, and in a case in which the determination is NO, the control unit 18 advances the processing to Step S7.

In Step S6, the control unit 18 causes the display unit 11 to display images in areas within a predetermined range from a detected position P in an enlarged manner. Subsequently, the control unit 18 advances the processing to Step S12.

In Step S7, the control unit 18 determines whether the detected distance D is longer than the third distance d₃, and is no more than the second distance d₂. In a case in which the determination is YES, the control unit 18 advances the processing to Step S8, and in a case in which the determination is NO, the control unit 18 advances the processing to Step S9.

In Step S8, the control unit 18 causes the display unit 11 to display images in an area, which is displayed in an enlarged manner, in a statical manner. Subsequently, the control unit 18 advances the processing to Step S12.

In Step S95, the control unit 18 determines whether the detected distance D is longer than 0 (zero), and is no more than the third distance d₃. In a case in which the determination is YES, the control unit 18 advances the processing to Step S10, and in a case in which the determination is NO, the control unit 18 advances the processing to Step S11.

In Step S10, the control unit 18 changes the display manner of an image in an area corresponding to the detected position P. Here, the control unit 18 changes the color of the image in the area corresponding to the detected position P so as to be different from the color of the images in the other areas. Subsequently, the control unit 18 advances the processing to Step S12.

In Step S11, the distance D is 0 (zero), i.e. the contact detecting unit 12 detects contact. In other words, in Step S11, the control unit 18 accepts an input of the key corresponding to the image corresponding to the position (position P) that was touched. Subsequently, the control unit 18 advances the processing to Step S12.

In Step S12, via the contact detecting unit 12, the control unit 18 determines whether an operation to finish inputting was accepted. In a case in which the determination is YES, the control unit 18 terminates the processing in the present flowchart, and in a case in which the determination is NO, the control unit 18 advances the processing to Step S3.

As described above, according to the present embodiment, in a case in which an object such as a finger or stylus of the user is brought closer to the display surface of the display unit 11, the cellular telephone device 1 causes the display unit 11 to display images, which are displayed within a predetermined range of the display surface of the display unit 11 facing the object, in an enlarged manner. Therefore, the cellular telephone device 1 can improve the operability for areas within a predetermined range, and can suppress incorrect inputs. Moreover, in a case in which the object such as a finger or stylus of the user is brought closer to an image corresponding to a key that the user is going to input, the cellular telephone device 1 displays images, which are displayed within a predetermined range from the image in a position close to the object, in an enlarged manner. Accordingly, the cellular telephone device 1 can improve the visibility of the keys, and can enlarge the touch-sensitive images corresponding to the keys; therefore, it is possible to suppress incorrect inputs of keys.

Although the preferable embodiments have been described above, the present invention is not limited to the aforementioned embodiments, and can be implemented as various embodiments. In addition, the effects described in the embodiment merely exemplify the most preferable effects arising from the present invention, and the effects according to the present invention are not limited to those described above.

For example, although the present invention was described by using the QWERTY virtual keyboard in the present embodiment, a virtual keyboard is not limited to the QWERTY virtual keyboard. In other words, the virtual keyboard may be a virtual keyboard having other key arrangements, such as a virtual keyboard of numeric keys.

Furthermore, although the present embodiment was described for a case in which only one object such as a finger or stylus of the user is brought closer to the display unit 11, it is not limited thereto. In a case in which a plurality of objects are brought closer to the display unit 11, the control unit 18 of the cellular telephone device 1 may display images within predetermined ranges from positions of the display unit 11 in an enlarged manner, the positions corresponding to a distance between each object and the display surface of the display unit 11.

It should be noted that, although the cellular telephone device 1 was described as a portable electronic device in the present embodiment, it is not limited thereto, and may be a portable electronic device including a touch panel, such as a PHS (Personal Handyphone System), a PDA (Personal Digital Assistant), a portable navigation device, a personal computer, a notebook PC, a mobile gaming device or the like.

What is claimed is:

1. A portable electronic device, comprising:
a display unit;
a contact detecting unit that detects contact of an object to the display unit;
a proximity detecting unit that detects proximity of the object in proximity to a display surface of the display unit; and
a control unit that causes the display unit to display images, which are displayed within a predetermined range of the display surface facing the object, in an enlarged manner, in a case in which the proximity detecting unit detects proximity of the object to the display surface.

2. The portable electronic device according to claim 1,
wherein the proximity detecting unit detects a distance between the object in proximity to the display unit and the display surface of the display unit, and a position on the display unit corresponding to the distance, and
wherein the control unit causes the display unit to display a keyboard configured with a plurality of images displaying keys, accepts an input of the key corresponding to the image in response to the contact detecting unit having detected contact of the object to the image, and causes the display unit to display the images, which are displayed within a predetermined range from the position on the display unit detected by the proximity detecting unit, in an enlarged manner.

3. The portable electronic device according to claim 2, wherein, in a case in which the distance detected by the proximity detecting unit is shorter than a first distance, the control unit causes the display unit to display the images, which are displayed within the predetermined range, in an enlarged manner.

4. The portable electronic device according to claim 1,
wherein the control unit causes the display unit to display the images, which are displayed within the predetermined range, in an enlarged and semi-transmissive manner.

5. The portable electronic device according to claim 3,
wherein, in a case in which the distance detected by the proximity detecting unit is shorter than a second distance that is shorter than the first distance, the control unit performs control such that the images, which are displayed in an enlarged manner on the display unit, are displayed without any changes in accordance with the position.

6. The portable electronic device according to claim 5,
wherein, in a case in which the distance detected by the proximity detecting unit is shorter than the second distance, the control unit performs control such that the images, which are displayed in an enlarged manner on the display unit, are displayed in a highlighted and statical manner.

7. The portable electronic device according to claim 5,
wherein, in a case in which the distance detected by the proximity detecting unit is shorter than a third distance that is shorter than the second distance, the control unit changes a display manner of the image corresponding to the position on the display unit detected by the proximity detecting unit, and
accepts an input of the key corresponding to the image whose display manner was changed in response to the contact detecting unit having detected contact of the object to the display unit.
